(19) United States
(12) Patent Application Publication
(10) Pub. No.: US 2015/0159096 A1
(43) Pub. Date: Jun. 11, 2015

(54) FUEL GASIFICATION SYSTEM, CONTROL METHOD AND CONTROL PROGRAM THEREFOR, AND FUEL GASIFICATION COMBINED POWER GENERATION SYSTEM PROVIDED WITH FUEL GASIFICATION SYSTEM

(71) Applicant: MITSUBISHI HEAVY INDUSTRIES, LTD., Tokyo (JP)

(72) Inventors: Takanori Tsutsumi, Tokyo (JP); Hiromi Ishii, Tokyo (JP); Takashi Fujii, Tokyo (JP); Yoshinori Koyama, Tokyo (JP)

(21) Appl. No.: 14/361,406

(22) PCT Filed: Nov. 26, 2012
(86) PCT No.: PCT/JP2012/080454

§ 371 Date: May 29, 2014

(30) Foreign Application Priority Data
Dec. 6, 2011 (JP) 2011-266930

(51) Int. Cl. C10J 3/72; G05B 15/02; C10J 3/50; C10L 3/00; F02C 3/22; C10J 3/48

(52) U.S. Cl. CPC C10J 3/723; F02C 3/22; C10J 3/485; C10J 3/506; C10L 3/00; G05B 15/02; C10J 2200/15; C10L 2290/04; C10L 2290/58; C10L 2290/145

(57) ABSTRACT

It is intended to provide a fuel gasification system, a control method and a control program for the fuel gasification system, and a fuel gasification combined power generation system provided with the fuel gasification system, whereby even when types and properties of the fuel changes, a calorific value of combustible gas produced by gasification of the fuel is stable while increase or decrease in the amount of char generation is suppressed. A control device (26) of a fuel gasification system (12) controls, depending on an indicator corresponding to the calorific value (SG calorific value) of the combustible gas, the supply of the fuel to a gasification furnace (16) and the supply of the oxygen gas to the gasification furnace (16) so as to change a ratio of the supply of the oxygen gas to the supply of the air supplied to the gasification furnace (16).

### TECHNICAL FIELD

The present invention relates to a fuel gasification system, a control method and a control program for a fuel gasification system, and a fuel gasification combined power generation system provided with a fuel gasification system and, in particular, to a technology to keep a stable calorific value of combustible gas generated by gasification of fuel.

### BACKGROUND ART

In recent years, an integrated coal gasification combined cycle (IGCC) system has been developed and put to practical use. The integrated coal gasification. combined cycle system has higher power generation efficiency than a conventional coal-fired thermal power generation system, and thus friendly to the environment.

The integrated coal gasification combined cycle system is composed by combining a coal gasification system and a gas turbine combined cycle (GTCC) system.

A coal gasification system is provided with a gasification furnace, a coal supply unit and an air supply unit, and is configured so that coal supplied from the coal supply unit is combusted with air supplied from the air supply unit as an oxidizing agent so as to be gasified.

Meanwhile, a GTCC system is provided with a gas turbine device, a steam turbine, an exhaust heat recovery boiler and a generator. The gas turbine device is provided with a gas turbine, a compressor and a combustor, and is configured so that combustible gas obtained by gasification of coal and air from the compressor is supplied to the combustor. Combustion gas generated by the combustion of the combustible gas in the combustor drives the gas turbine, and then enters the exhaust heat recovery boiler to generate steam which then drives the steam turbine. In this manner, the combustible gas serves as fuel to drive the gas turbine and the steam turbine, and the generator converts the output of the gas turbine and the steam turbine into electric power.

The compressor of the gas turbine device also has a function as an air supply unit for the coal gasification system.

The integrated coal gasification combined cycle system is typically operated to keep a constant power generation amount of the generator. However, with changes in types and properties of coal serving as a fuel, the calorific value of the combustible gas obtained by gasification is changed. This may results in change in the power generation. Thus, when the calorific value decreases, the control for increasing the amount of coal and air supplied to the gasification furnace is performed. By this control, after increasing the amount of generated combustible gas, the supply amount of combustible gas to the combustor is increased, thereby preventing reduction of the calorific value of the combustor and also preventing reduction of the power generation amount.

However, the source of air supplied to the gasification furnace is the compressor of the gas turbine device and thus, when increasing the amount of air supplied to the gasification furnace, the amount of gas air supplied to the combustor is reduced and the output of the turbine is lowered. As a result, the power generation amount of the generator decreases. Therefore, in the integrated coal gasification combined cycle system using the compressor of the gas turbine device as a source of air supplied to the gasification furnace, if the calorific value decreases, it is difficult to keep a constant power generation amount.

Therefore, in an integrated coal gasification combined cycle system disclosed in Patent Document 1, when the calorific value of the combustible gas is decreased, an amount of supplied coal is increased while keeping a constant supply of coal. Therefore, the amount of generated combustible gas is increased without reducing the amount of air supplied to the combustor from the compressor, the amount of generated combustible gas is increased. As a result, the power generation amount is kept constant.

Additionally, it is also proposed in Patent Document 1 to, in the case where the gasification furnace has a two-stage entrained bed of upper and lower stages, change a ratio of the fuel supplied to the upper stage to the total fuel (an R/T ratio) so as to adjust the calorific value when the calorific value decreases.

### CITATION LIST

### Patent Document

[Patent Document 1]

JP 2010-285564 A

### SUMMARY

### Technical Problem

In the case where the supply amount of coal calorific is increased when the calorific value of the combustible gas decreases, an amount of generated char consisting of ash and fixed carbon in the gasification furnace increases. The char is separated and recovered from the combustible gas by a char recovery unit connected to the gasification furnace, and the recovered char is re-introduced into the gasification furnace. While there is a limit to the capacity of the char recovery unit, blow-by of combustible gas occurs when the amount of char inside the char recovery unit becomes low. For this reason, there are problems that it is necessary to keep a stable amount of char generated in the gasification furnace and that it is undesirable to increase or decrease the amount of char generation.

Similar problems occur when the R/T ratio is adjusted.

The present invention has been made in view of the above problems, and has an object to provide a fuel gasification system, a control method and a control program for the fuel gasification system, and a fuel gasification combined power generation system provided with the fuel gasification system, whereby even when types and properties of the fuel changes, a calorific value of combustible gas produced by gasification of the fuel is stable while increase or decrease in an amount of char generation is suppressed.

### Solution to Problem

In order to solve the above problems, the present invention employs the followings.

The present invention provides a fuel gasification system comprising:

a gasification furnace configured to combust and gasify fuel so as to generate combustible gas;

an air supply device configured to supply air to the gasification furnace;

a oxygen-enriched oxidizer supply device including an air separator for separating air into nitrogen gas and oxygen gas, the oxygen-enriched oxidizer supply device being configured to supply the oxygen gas separated by the air separator to the gasification furnace;

a fuel supply device configured to supply the fuel to the gasification furnace by using the nitrogen gas separated. by the air separator; and

a control device configured to control the air supply device, the oxygen-enriched oxidizer supply device and the fuel supply device, the control device being configured to control, depending on an indicator that corresponds to a calorific value of the combustible gas, an amount of the fuel supplied to the gasification furnace and an amount of the oxygen gas supplied to the gasification furnace so as to change a ratio of the amount of the oxygen gas supplied to the gasification furnace to the amount of the air supplied to the gasification furnace.

In this fuel gasification system, if the indicator corresponding to the calorific value of the combustible gas produced by gasification changes, the supply of oxygen gas to the gasification furnace is controlled together with the supply of the fuel. As a result, the change in the calorific value of the combustible gas is suppressed while suppressing the change in the amount of air supplied to the gasification furnace.

Therefore, in the case where this fuel gasification system is applied to a fuel gas combined-cycle power generation system, even if the calorific value of the combustible gas changes, it is possible to suppress the change in amount of air supplied to the gasification furnace from the compressor of the gas turbine system. As a result, the output of the gas turbine is stabilized, and the power generation amount by the generator is also stabilized. Therefore, the fuel gas combined power generation system is operated stably.

Further, in the case of controlling the supply of fuel and oxygen gas to the gasification furnace, as compared with the case of controlling only the supply of the fuel, the amount of char generated in the gasification furnace is stabilized, and excessive generation or shortage of char can be prevented. Therefore, the fuel gasification system is operated stably.

Furthermore, in the case controlling the supply of the fuel and oxygen gas, as compared with the case of controlling the supply of the fuel and the air, fuel pressure fluctuation of the combustible gas is suppressed. From this point as well, the fuel gasification system is operated stably.

As a preferred configuration, the control device is configured to control the amount of the fuel and the amount of the oxygen gas supplied to the gasification furnace depending on the calorific value of the combustible gas as the indicator.

With this configuration, with the calorific value of the combustible gas as a control target, the supply of the oxygen gas and the fuel is controlled. Thus, the change in the calorific value of the combustible gas is reliably suppressed.

As a preferred configuration, the control device is configured to control the amount of the fuel and the amount of the oxygen gas supplied to the gasification furnace depending on an amount of char generated in the gasification furnace as the indicator.

With this configuration, with the amount of char generated in the gasification as the control target, the supply of the fuel and the oxygen gas is controlled. Thus, the change of the amount of the char generated can be reliably suppressed.

Further, the present invention provides a control method for a fuel gasification system which comprises: a gasification furnace configured to combust and gasify fuel so as to generate combustible gas; an air supply device configured to supply air to the gasification furnace; an air separator configured to separate air into nitrogen gas and oxygen gas; a oxygen-enriched oxidizer supply device configured to supply the oxygen gas separated by the air separator to the gasification furnace; and a fuel supply-device configured to supply the fuel to the gasification furnace by using the nitrogen gas separated by the air separator. The control method comprises the step of: controlling, depending on an indicator that corresponds to a calorific value of the combustible gas, an amount of the fuel supplied to the gasification furnace and an amount of the oxygen gas supplied to the gasification furnace so as to change a ratio of the amount of the oxygen gas supplied to the gasification furnace to the amount of the air supplied to the gasification furnace.

In this control method for a fuel gasification system, if the indicator corresponding to the calorific value of the combustible gas produced by gasification changes, the supply of oxygen gas is controlled with the supply of the fuel. Thus, the change in the calorific value of the combustible gas is suppressed while suppressing change in the supply of the air.

Therefore, in the case where the control method for the fuel gasification system is applied to the fuel gas combined power generation system, even if the calorific value of the combustible gas changes, it is possible to suppress change in the amount of air supplied to the gasification furnace from the compressor of the gas turbine system. As a result, the output of the gas turbine is stabilized, and the power generation amount by the generator is also stabilized. Therefore, the fuel gas combined power generation system is operated stably.

Further, when controlling the supply of the fuel and the oxygen gas, as compared with the case of controlling only the supply of the fuel, the amount of char generated in the gasification furnace is stabilized, excessive generation or shortage of char can be prevented. Therefore, the fuel gasification system is operated stably.

Furthermore, when controlling the supply of the fuel and the oxygen gas, as compared with the case of controlling the supply of the fuel and the air, fuel pressure fluctuation of the combustible gas is suppressed. From this point as well, the fuel gasification system is operated stably.

The present invention also provides a control program for a fuel gasification system which comprises: a gasification furnace configured to combust and gasify fuel so as to generate combustible gas; an air supply device configured to supply air to the gasification furnace; an air separator configured to separate air into nitrogen gas and oxygen gas; a oxygen-enriched oxidizer supply device configured to supply the oxygen gas separated by the air separator to the gasification furnace; a fuel supply device configured to supply the fuel to the gasification furnace by using the nitrogen gas separated by the air separator; and a control device configured to control the air supply device, the oxygen-enriched oxidizer supply device and the fuel supply device, wherein the control program is operable to make the control device to realize a function of controlling, depending on an indicator that corresponds to a calorific value of the combustible gas, an amount of the fuel supplied to the gasification furnace and a function of controlling an amount of the oxygen gas supplied to the gasification furnace so as to change a ratio of the amount of the oxygen gas to the amount of the air supplied to the gasification furnace.

In this control program for a fuel gasification system, if the indicator corresponding to the calorific value of the combustible gas produced by gasification changes, the supply of oxygen gas is controlled with the supply of the fuel. Thus, the change in the calorific value of the combustible gas is suppressed while suppressing change in the supply of the air.

Therefore, in the case where this control program for the fuel gasification system is applied to the fuel gas combined power generation system, even if the calorific value of the combustible gas changes, it is possible to suppress change in the amount of air supplied to the gasification furnace from the compressor of the gas turbine system. As a result, the output of the gas turbine is stabilized, and the power generation amount by the generator is also stabilized. Therefore, the fuel gas combined power generation system is operated stably.

Further, when controlling the supply of the fuel and the oxygen gas, as compared with the case of controlling only the supply of the fuel, the amount of char generated in the gasification furnace is stabilized, excessive generation or shortage of char can be prevented. Therefore, the fuel gasification system is operated stably. Furthermore, when controlling the supply of the fuel and the oxygen gas, as compared with the case of controlling the supply of the fuel and the air, fuel pressure fluctuation of the combustible gas is suppressed. From this point as well, the fuel gasification system is operated stably.

Moreover, the present invention provides a fuel gasification combined power generation system comprising:

a gasification furnace configured to combust and gasify fuel so as to generate combustible gas;

a combustor configured to combust the combustible gas to generate combustion gas;

a gas turbine configured to be driven by combustion gas generated by the combustor;

a generator configured to generate electric power using output of the gas turbine;

an air supply device configured to supply air to the gasification furnace;

a compressor configured to supply air to the combustor, the compressor serving as a part of the air supply device;

a oxygen-enriched oxidizer supply device including an air separator for separating air into nitrogen gas and oxygen gas, the oxygen-enriched oxidizer supply device being configured to supply the oxygen gas separated by the air separator to the gasification furnace;

a fuel supply device configured to supply the fuel to the gasification furnace by using the nitrogen gas separated by the air separator; and

a control device configured to control the air supply device, the oxygen-enriched oxidizer supply device and the fuel supply device so that a power generation amount of the generator approaches a target value, the control device being configured to control, depending on an indicator that corresponds to a calorific value of the combustible gas, an amount of the fuel supplied to the gasification furnace and an amount of the oxygen gas supplied to the gasification furnace so as to change a ratio of the amount of the oxygen gas supplied to the gasification furnace to the amount of the air supplied to the gasification furnace.

In this fuel gasification combined power generation system, if the indicator corresponding to the calorific value of the combustible gas produced by gasification changes, the supply of oxygen gas is controlled with the supply of the fuel. Thus, the change in the calorific value of the combustible gas is suppressed while suppressing change in the supply of the air.

Therefore, even if the calorific value of the combustible gas changes, it is possible to suppress change in the amount of air supplied to the gasification furnace from the air supply device. As a result, the change in the supply of the air to the combustor from the air supply device is suppressed, the output of the gas turbine is stabilized, and the power generation amount by the generator is also stabilized. Therefore, the fuel gas combined power generation system is operated stably.

Further, when controlling the supply of the fuel and the oxygen gas, as compared. with the case of controlling only the supply of the fuel, the amount of char generated in the gasification furnace is stabilized, excessive generation or shortage of char can be prevented. Therefore, the fuel gasification combined power generation system is operated stably.

Furthermore, when controlling the supply of the fuel and the oxygen gas, as compared with the case of controlling the supply of the fuel and the air, fuel pressure fluctuation of the combustible gas is suppressed. From this point as well, the fuel gasification combined power generation system is operated stably.

### Advantageous Effects

According to the present invention, it is possible to provide the fuel gasification system, the control method and the control program for the fuel gasification system, and the fuel gasification combined power generation system provided with the fuel gasification system, whereby even when types and properties of the fuel changes, the calorific value of combustible gas produced by gasification of the fuel is stable while increase or decrease in the amount of char generation is suppressed.

### BRIEF DESCRIPTION OF DRAWINGS

[FIG. 1]

FIG. 1 is a diagram showing a schematic overall configuration of a fuel gasification combined power generation system according to a first embodiment of the present invention.

[FIG. 2]

FIG. 2 is a block diagram schematically showing a functional configuration of a control device of FIG. 1.

[FIG. 3]

FIG. 3 is a block diagram schematically showing a functional configuration of a gasification furnace control unit of FIG. 2.

[FIG. 4]

FIG. 4 is a block diagram showing the content of operation performed in each block of FIG. 3.

[FIG. 5]

FIG. 5 is a timing chart showing a reference example of the operation of the fuel gasification combined power generation system of FIG. 1, in a state of stopping a function of a fuel• oxygen-enriched oxidizer flow rate command value correcting part.

[FIG. 6]

FIG. 6 is a timing chart showing another reference example of the operation of the fuel gasification combined power generation system of FIG. 1, in a state of stopping a function of the fuel• oxygen-enriched oxidizer flow rate command value correcting part.

[FIG. 7]

FIG. 7 is a timing chart showing one example of the operation of the fuel gasification combined power generation system of FIG. 1, in a state of stopping a function of the fuel• oxygen-enriched oxidizer flow rate command value correcting part.

[FIG. 8]

FIG. 8 is a block diagram schematically showing a functional configuration of a gasification furnace control unit according to a second embodiment.

[FIG. 9]

FIG. 9 is a block diagram showing the content of operation performed in each block of FIG. 8.

[FIG. 10]

FIG. 10 is a block diagram schematically showing a functional configuration of a gasification furnace control unit according to a third embodiment.

[FIG. 11]

FIG. 11 is a block diagram showing the content of operation performed in each block of FIG. 10.

[FIG. 12]

FIG. 12 is a block diagram schematically showing a functional configuration of a gasification furnace control unit according to a fourth embodiment.

[FIG. 13]

FIG. 13 is a block diagram showing the content of operation performed in each block of FIG. 12.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not limitative of the scope of the present invention.

### First Embodiment

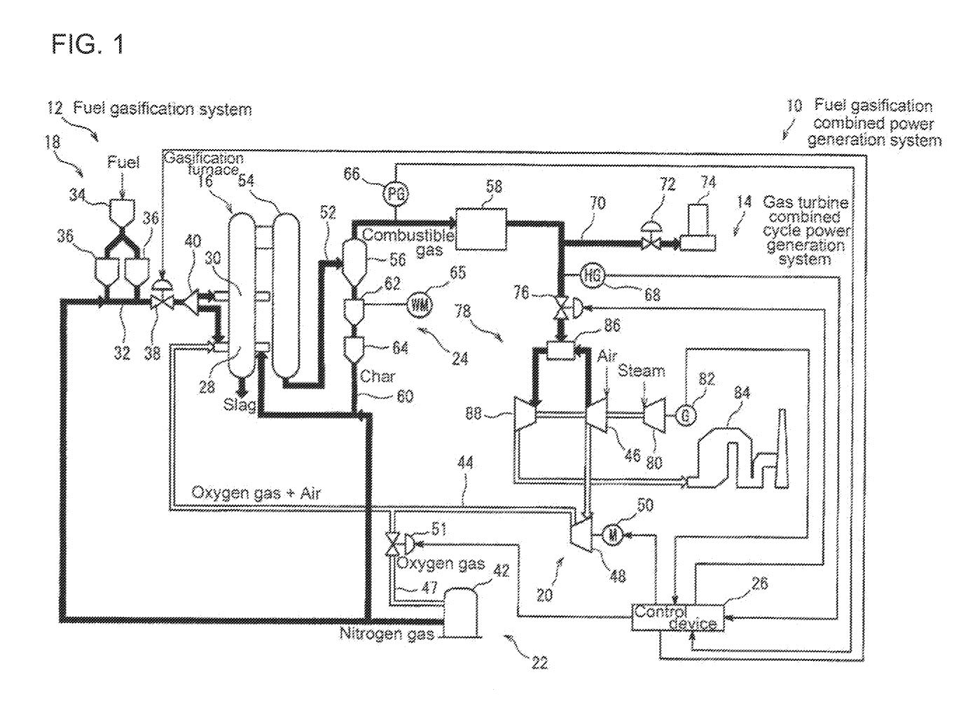

FIG. 1 shows a schematic overall configuration of a fuel gasification combined power generation system (hereinafter, also referred to as IGCC) 10 according to a first embodiment of the present invention. If the fuel is coal, the IGCC 10 is an integrated coal gasification combined cycle system.

The IGCC 10 is formed by a fuel gasification system 12 and a gas turbine combined cycle power generation system (hereinafter also referred to GTCC) 14. The fuel gasification system 12 is configured to generate combustible gas by gasification of fuel, and the GTCC 14 is configured to generate electric power using the combustible gas. When the fuel is coal, the fuel gasification system 12 is a coal gasification system.

### [Fuel Gasification System]

The fuel gasification system 12 comprises a gasification furnace 16, a fuel supply device 18 configured to supply coal as fuel to the gasification furnace 16, an air supply device 20 configured to supply air as oxidizer to the gasification furnace 16, a oxygen-enriched oxidizer supply device 22 configured to supply oxygen gas as oxygen-enriched oxidizer to the gasification furnace 16, and a gas processing device 24 configured to process the combustible gas generated in the gasification furnace 16. The fuel gasification system 12 includes a control device 26. This control device 26 is configured to control the fuel supply device 18, the air supply device 20, and the oxygen-enriched oxidizer supply device 22.

The control device 26 is also configured to control the GTCC 14 so as to control the entire IGCC 10.

[Gasification Furnace]

The gasification furnace 16 is an entrained bed type having upper and lower stages which are an upper entrained bed (combustor) 28 and a lower entrained bed (reductor) 30. Pulverized coal is supplied to a burner of the combustor 28 and a burner of the reductor 28. Further, air and oxygen gas is supplied to the burner of the combustor 28, and when the coal is combusted in the combustor 28, combustible gas is generated by coal gasification in the reductor 30.

### [Fuel Supply Device]

The fuel supply device 18 includes a, fuel supply passage 32 extending from the reductor 30 and the combustor 28. In the fuel supply passage 32, a fuel bottle 34, a fuel hopper 36, a fuel flow regulating valve 38, and a distribution device 40 are provided in this order in the flow direction of the coal.

The fuel bottle 34 is configured to temporarily store pulverized coal supplied from a pulverization device (not shown). The fuel hopper 36 is configured to supply the coal in the fuel bottle 34 to the downstream of the fuel supply passage 32.

The fuel supply device 18 includes an air separator (ASU: Air Separator Unit) 42. The air separator 42 is configured to separate air into nitrogen gas and oxygen gas. The separated nitrogen gas is supplied as carrier gas to the fuel supply passage 32, and the coal supplied form the fuel hopper 36 is carried by the carrier gas.

The fuel flow regulating valve 38 is configured to regulate the flow rate of the coal based on a command from the control device 26. The distribution device 40 is configured to supply coal to the combustor 28 and the reductor 30 in an appropriate distribution ratio. The distribution ratio may be fixed or may be variable.

### [Air Supply Device]

The air supply device 20 includes an air supply passage 44 extending to the combustor 28. Some of the air pressurized by a compressor (GT air compressor) 46 is bled and is supplied to a booster 48 to boost the extracted air from the compressor 46. The bleed air boosted by the booster 48 is sent to the combustor 28 of the gasification furnace 16.

The booster 48 is driven by a motor 50, and the motor 50 is controlled by the control device 26 so that the air flow rate is controlled by a motor speed or an inlet vane of the booster 48.

### [Oxygen-Enriched Oxidizer Supply Device]

The air separator 42 serves as a part of the oxygen-enriched oxidizer supply device 22. The oxygen-enriched oxidizer supply device 22 includes an oxygen-enriched oxidizer supply passage 47 connecting an oxygen gas discharge port of the air separator 42 to a downstream section of the air supply passage 44 with respect to the booster 48. Therefore, the oxygen gas separated by the air separator 42 is supplied to the combustor 28 through the oxygen-enriched oxidizer supply passage 47 and a part of the air supply passage 44.

Further, an oxygen-enriched oxidizer flow regulating valve 51 is provided in the oxygen-enriched oxidizer supply passage 47. The oxygen-enriched oxidizer flow regulating valve 51 is controlled by the control device 26. In other words, the amount of oxygen gas supplied to the gasification furnace 16 is controlled by the control device 26.

### [Gas Processing Device]

The gas processing device 24 includes a combustible gas supply passage 52 extending from the top of the gasification 16 to the GTCC 14. In the combustible gas supply passage 52, a heat exchanger (a syngas cooler) 54, a char recovery unit 56 and a gas purifier 58 are provided in this order in the flow direction of the combustible gas.

In the syngas cooler 54, the combustible gas is cooled to an appropriate temperature. In this process, steam vapor is generated by heat exchange, and the generated steam vapor is supplied to the GTCC 14.

The char recovery unit 56 separates the char from the combustible gas. The char recovery unit 56 is connected to the combustor 28 via a char return passage 60. In the char return passage 60, a char bin 62 and a char hopper are provided in this order in the flow direction of the char. The nitrogen gas is supplied. as carrier gas to the char return passage 60 from the air separator 42, and the char is carried to the combustor 28 by the carrier gas.

A meter (WM) 65 is attached to the char bin 62 to measure an amount of the char stored in the char bin 62 as a value corresponding to the generation amount of char. The meter 65, for example, is constituted by a level sensor or a storage amount sensor that is capable of detecting the position of the upper end of the char. The storage amount of the char was measured by the meter 65 (char generation amount) is input to the control device 26, if necessary.

The gas purifier 58, for example, is constituted by a dust removing device and a desulfurizer to remove dust and sulfur components from the combustible gas.

To the combustible gas supply passage 52, a pressure gauge (PG) 66 for detecting a pressure of the combustible gas (a pressure of system gas) produced by gasification of the fuel, and a calorific value meter (HG) 68 for detecting the calorific value of the gas system are attached. The calorific value of the system gas is the amount of heat generated by combustion of a certain amount of the system gas. The calorific value changes as types and concentration of combustible component in the system gas changes, depending on types and properties of the fuel and further depending on conditions of gasification in the gasification furnace 16.

In this embodiment, as an example, the pressure gauge 66 is attached to a part of the combustible gas supply passage 52 extending between the char recovery unit 56 and the gas purifier 58, the calorific value meter 68 is attached to a downstream part of the combustible gas supply passage disposed downstream from the gas purifier 58.

Further, a branch passage 70 is connected to the downstream part of the combustible gas supply passage 52 disposed downstream from the gas purifier 58. In the branch passage 70, a release flow regulating valve 72 and a ground flare 74 are provided. The ground flare 74 is configured to combust unneeded combustible gas into harmless clean gas to release the clean gas into the atmosphere.

### [Gas Turbine Combined Cycle Power Generation System]

The GTCC 14 comprises a combustible gas flow regulating valve 6, a gas turbine device 78, a steam turbine 80, a generator (G) 82, a exhaust heat recovery boiler 84.

The combustible gas flow regulating valve 76 is provided near the outlet of the combustible gas supply passage 52. The combustible gas flow regulating valve 76 is controlled by the control device 26. Specifically, the control device 26 also serves to control the GTCC 14.

### [Gas Turbine Unit]

The gas turbine device 78 includes a compressor 46, a combustor 86, and a gas turbine 88. The compressor 46 is a turbo compressor configured to take in air from the atmosphere and send the air toward the combustor 86. As described above, the compressor 46 also has a function as an air supply source for the air supply device 20, and also serves as a part of the air supply device 20.

The outlet of the combustible gas supply passage 52 is connected to the combustor 86 where the combustible gas is combusted The combustion gas generated in the combustor 86 drives the gas turbine 88, is then sent to the exhaust heat recovery boiler 84, and is finally released from a stack of the exhaust heat recovery boiler 84.

### [Steam Turbine]

The steam generated in the exhaust heat recovery boiler 84 and the syngas cooler 54 is supplied to the steam turbine 80, and hence the steam turbine 80 is driven by the supplied steam.

### [Generator]

In the present embodiment, a rotation shaft of the generator 82 is connected coaxially with rotation shafts of the gas turbine 88, the compressor 46 and the steam turbine 80. The generator 82 is configured to generate electric power by converting a rotational force, which is the output of the gas turbine 88 and the steam turbine, into electric power. The detection value of the power generated by the generator 82 (the output) is input to the control device 26.

### [Control Device]

The control device 26 is described in details below.

The control device is, for example, composed of a computer and includes a storage unit for storing a control program, an arithmetic unit for executing the control program, I/O interface, and the like.

The control program may be stored in a computer-readable recording medium. As the recording medium, magnetic disk, optical disk, CD-ROM, DVD-ROM, a semiconductor memory, or the like may be used. Alternatively, the control program may be distributed to the computer through a communication line.

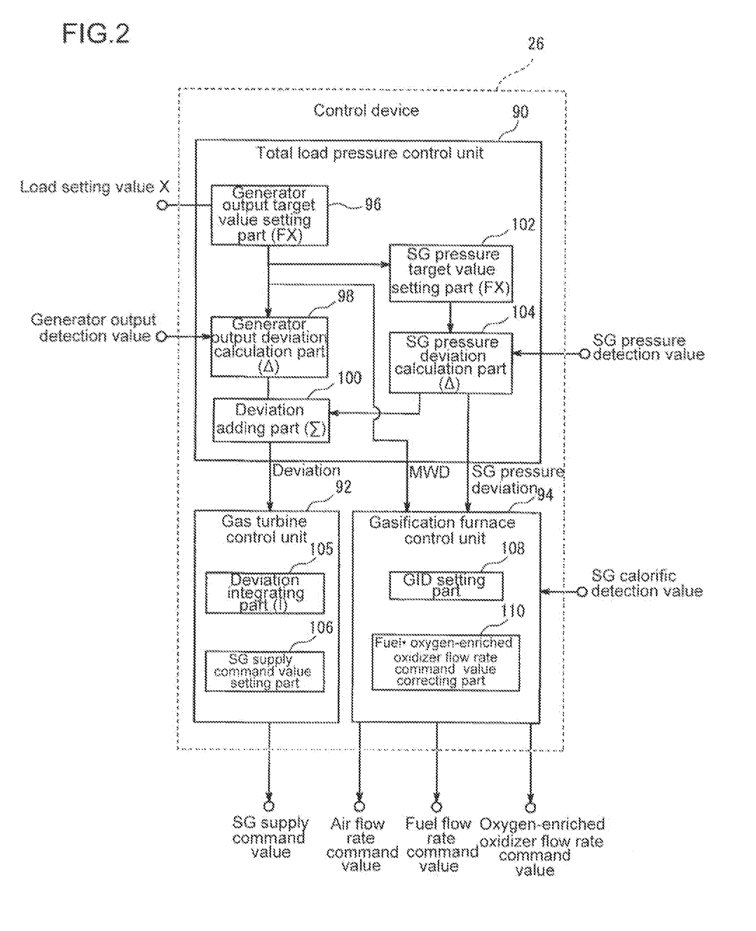

FIG. 2 is a block diagram showing the functional configuration of the control device 26. The control unit 26 has an overall load pressure control unit 90, a gas turbine control unit 94 and a gasification furnace control unit 94.

### [Total Load Pressure Control Unit]

The total load pressure control unit 90 includes a generator target output setting part 96, a generator output deviation calculating unit 98, a deviation adding part 100, a SG target pressure setting part 102 and a SG pressure deviation calculation part 104.

Based on a load set value X which is manually entered by an administrator, the generator target output setting part 96 sets a target value of the output of the generator 82 (MWD: Mega Watt Demand) by using an appropriate function (FX) or map data, for instance.

The generator output deviation calculation part 98 calculates a deviation (generator output deviation) between the detection value of the output of the generator 82 which is input from the generator 82 and the MWD set by the generator target output setting part 96.

Based on the MWD which is set by the generator target output setting part 96, the AG target pressure setting part 102 sets a target value of the SG pressure by using the appropriate function (FX) or map data.

The SG pressure deviation calculation part 104 calculates a deviation Δ (SG pressure deviation) between the detection value of the SG pressure input from pressure gauge 66 and the target value of the SG pressure set by SG target pressure setting part 102.

The deviation adding part 100 calculates the sum Σ of the generator output deviation calculated by the generator output deviation calculation part 98 and the SG pressure deviation calculated by the SG pressure deviation calculation part 104.

### [Gas Turbine Control Unit]

The gas turbine control unit 92 includes a deviation integrating part 105 and a SG supply command value setting part 106. The gas turbine control unit 92 integrates the sum of the generator output deviation and the SG pressure deviation calculated by the deviation adding part 100, over a prescribed period set in advance, to calculate the integrated value. The SG supply command value setting part 106 sets a command value of the supply amount of combustible gas supplied to the combustor 86 (SG supply amount) based on the integrated value obtained by the deviation integrating part 105 by using an appropriate function or map data. The command value of the SG supply amount is input to the combustible gas flow regulating valve 76, and the valve opening of the combustible gas flow regulating valve 76 is adjusted to approach the command value of the supply amount of combustible gas to the combustor 86.

### [Gasification Furnace Control Unit]

The gasification furnace control unit 94 includes a gasification furnace input command (GID) setting part 108 and a fuel• oxygen-enriched oxidizer flow rate command value correcting part 110, The gasification furnace control unit 94 calculates and outputs an air flow rate command value, a fuel flow rate command value and an oxygen-enriched oxidizer flow rate command value, based on the MWD which is set by the generator target output setting unit 96, the SG pressure deviation which is calculated by the SG pressure deviation calculation part 104, and the detection value of the calorific value of the system gas which is input from the calorific value meter 68.

The air flow rate command value is input to the booster 48 (the motor 50), and the rotation speed of an inlet vane of the booster 48 (or the motor 50) is adjusted so that the flow rate of the air supplied to the gasification furnace 16 becomes closer to the air flow rate command value.

The fuel flow rate command value is input to the fuel flow regulator valve 38, and the valve opening degree of the fuel flow regulating valve 38 is adjusted so that the flow rate of coal supplied to the gasification furnace 16 becomes closer to the fuel flow rate command value.

The oxygen-enriched oxidizer flow rate command value is input to the oxygen-enriched oxidizer flow control valve 51, and the valve opening of the oxygen-enriched oxidizer flow regulating valve 51 is adjusted so that the flow rate of the oxygen gas supplied to the gasification furnace 16 becomes closer to the oxygen-enriched oxidizer flow rate command value.

### [GID Setting Unit]

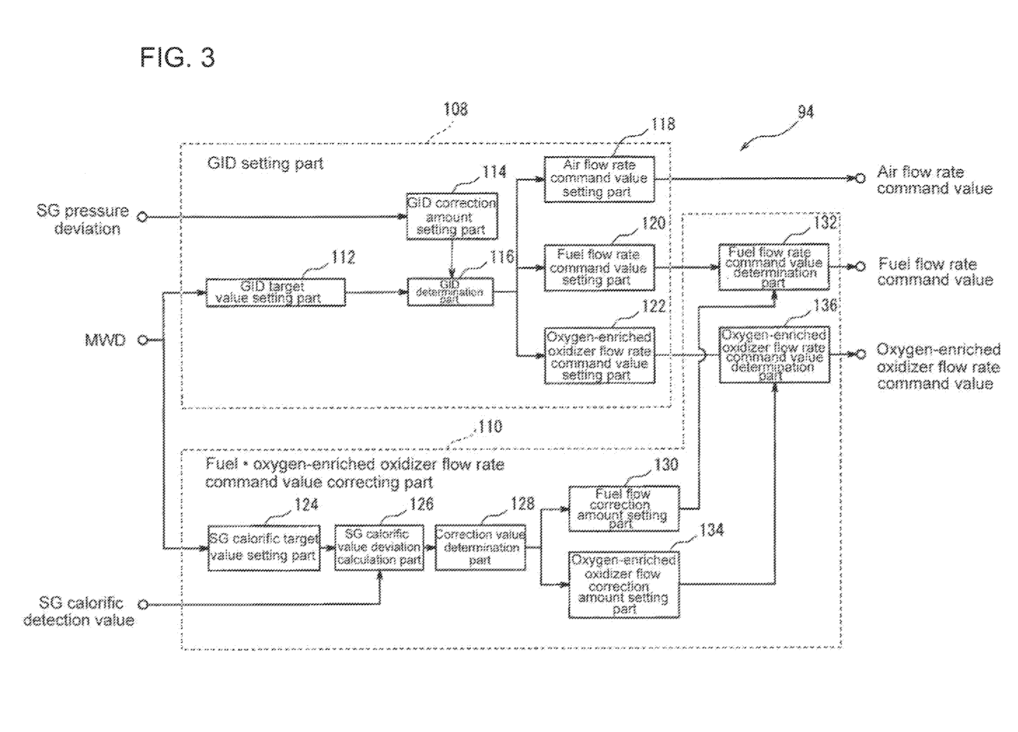

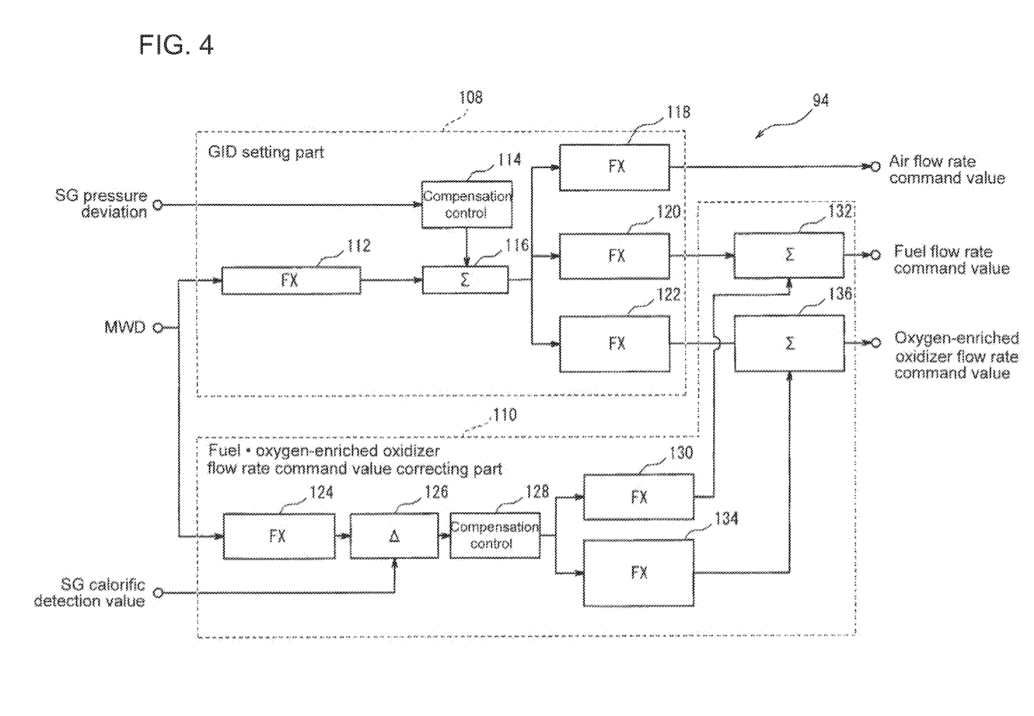

FIG. 3 illustrates the functional configuration of the gasification furnace control unit 94 in more detail. FIG. 4 shows the calculation content executed by each block of FIG. 3. FIG. 4 substantially shows the control method and control program performed by the gasification furnace control unit 94.

As shown in FIG. 3, the GID setting part 108 includes a GID target value setting part 112, a GID correction amount setting part 114, a GID determination part 116, an air flow rate command value setting part 118, a fuel flow rate command value setting part 120 and an oxygen-enriched oxidizer flow rate command value setting part 122.

Referring also to FIG. 4, the GID target value setting part 112 sets a GID target value based on the MWD which is set by the generator target output setting part 96, by using an appropriate function (FX) or map data). Meanwhile, the GID correction amount setting part 114 performs compensation control such as P (proportional) control, PI (proportional-integral) control and PID (proportional-integral-derivative) control. Specifically, the GID correction amount setting part 114 sets the GID correction amount based on the SG pressure deviation calculated by the SG pressure deviation calculation part 104, using an appropriate function (FX).

Then, the GID determination part 116 adds the correction amount for GID set by the GID correction amount setting part 114 and the target value for GID set by the GID target value setting part 112 to obtain the sum (Σ). The sum obtained in the above manner is determined as the corrected target value of the GID after correction.

Based on the corrected target value of the GM determined by the GID determination part 116, the air flow rate command value setting part 118 sets the air flow rate command value by using an appropriate function (FX) or map data.

Based on the corrected target value of the GID determined by the GID determination part 116, the fuel flow rate command value setting part 120 sets the fuel flow rate command value by using an appropriate function (FX) or map data

Based on the corrected target value of the GID determined by the GID determination part 116, the oxygen-enriched oxidizer flow rate command value setting part 122 sets the oxygen-enriched oxidizer flow rate command value by using an appropriate function (FX) or map data.

### [Fuel• Oxygen-Enriched Oxidizer Flow Rate Command Value Correcting Unit]

The fuel• oxygen-enriched oxidizer flow rate command value correcting unit 110 includes a SG calorific target value setting part 124, a SG calorific value deviation calculation part 126, a correction value determination part 128, a fuel flow correction amount setting part 130, a fuel flow rate command value determination part 132, an oxygen-enriched oxidizer flow correction amount setting part 134 and an oxygen-enriched oxidizer flow rate command value determination part 136.

Based on the MWD which is set by the generator target output setting part 96, the SG calorific target value setting part 124 sets the target value of the calorific value (SG calorific value) of the system gas, by using an appropriate function (FX) and map data.

The SG calorific value deviation calculation part 126 calculates the deviation (Δ) (SG calorific value deviation) between the target value of the SG calorific value set by the SG calorific target value setting part 124 and the SG calorific detection value input from the calorific value meter 68.

The correction variable determination part 1128 performs the compensation control such as P control, PI control and PID control. Specifically, based on the SG calorific value deviation calculated by the SG calorific value deviation calculation part 126, the correction variable determination part 128 determines the correction variables by using an appropriate function (FX) which is set in advance.

Based on the correction variable determined by the correction variable determination part 128, the fuel flow correction amount setting pat 130 sets the correction amount of the fuel flow rate by using an appropriate function (FX) or map data. Then, the fuel flow rate command value determination part 132 adds the fuel flow rate command value set by the fuel flow rate command value setting part 120 and the correction amount of the fuel flow rate set by the fuel flow correction amount setting part to obtain the sum (Σ). The sum obtained in this manner is determined as the command value of the fuel flow rate command value after correction.

Based on the correction variable for compensation which is determined by the correction variable determination part 128, the oxygen-enriched oxidizer flow correction amount setting part 134 sets the correction amount of the flow rate of the oxygen-enriched oxidizer by using an appropriate function (FX) or map data. Then, the oxygen-enriched oxidizer flow rate command value determination part 136 adds the command value of the oxygen-enriched oxidizer flow rate set by the oxygen-enriched oxidizer flow rate command value setting part 122, and the correction amount of the oxygen-enriched oxidizer flow rate set by the oxygen-enriched oxidizer flow correction amount setting part 134 to obtain (Σ). The result of summation (Σ) is determined as the target value of the oxygen-enriched oxidizer flow rate after correction.

Thus, as to the fuel flow rate command value and the oxygen-enriched oxidizer flow rate command value, the corrected command values are output, whereas as to the air flow rate command value, the air flow rate command value set by the air flow rate command value setting part 118 is directly output from the air flow rate command value setting part 118.

### [Operation]

The operation of IGCC 10, in other words, the control method of the IGCC 10 is now explained hereinafter. It should be noted that this operation is realized in such a manner that the control device 26 controls the IGCC 10 according to the control program of the IGCC 10 that is installed in the control device 26.

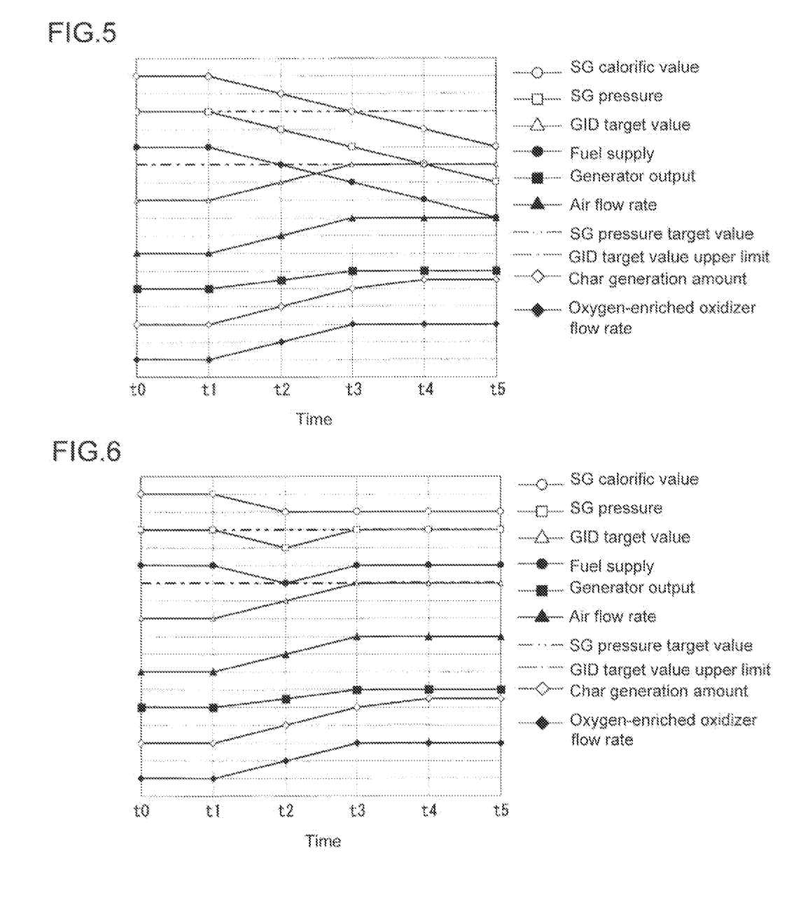

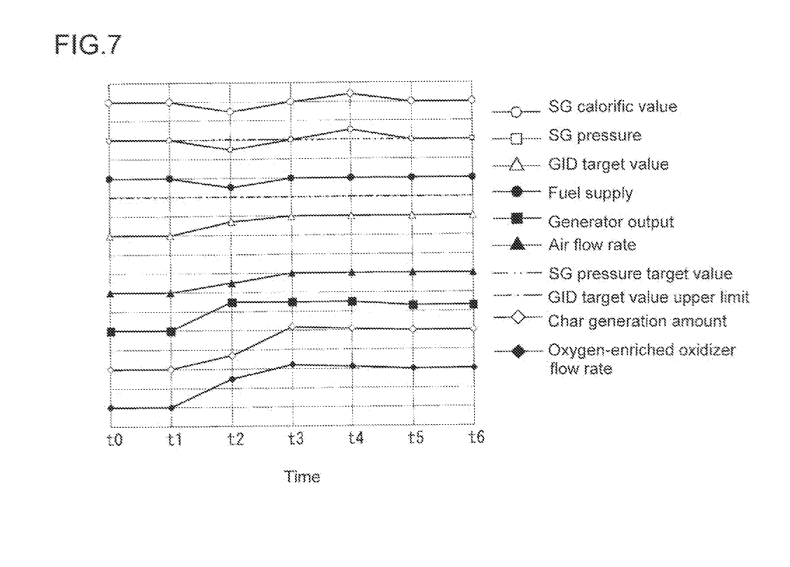

FIG. 5, FIG. 6 and FIG. 7 are time charts schematically showing temporal changes of parameters representing the operation state of the IGCC 10. In the time charts, the vertical axis represents the size of each parameter on an arbitrary scale, and the horizontal axis represents the time. Further, in any of the cases illustrated in FIG. 5, FIG. 6 and FIG. 7, the load set value X is always constant from the time t0 and thus, the generator output target value and the SG pressure target value are also constant.

However, in order to clarify the functions of the fuel• oxygen-enriched oxidizer flow rate command value correcting part 110, the operation of the IGCC 10 in the case where the functions of the fuel• oxygen-enriched oxidizer flow rate command value correcting part 110 are stopped is shown in FIG. 5 and FIG. 6 as a reference example of the operation of the case IGCC 10. Thus, in the cases of FIG. 5 and FIG. 6, the fuel flow rate command value set by the fuel flow rate command value setting part 120 and the oxygen-enriched oxidizer flow rate command value set by the oxygen-enriched oxidizer flow rate command value setting part 122 are directly output from the control device 26.

### [Case of FIG. 5 (Reference Example)]

### 1) From Time t0 to Time t1

The IGCC 10 is in the normal operating condition except that the function of the fuel• oxygen-enriched oxidizer flow rate command value correcting unit 110 is stopped.

### 2) From Time t1 to Time t3

For some reason or because of disturbance, such as a change in the properties of the coal, the calorific value (SG calorific value) of the combustible gas (system gas) detected by the calorific value meter 68 decreases gradually.

In this case, the amount of heat supplied to the gas turbine 88 from the combustor decreases, and the detection value of the generator output decreases. Thus, the generator output deviation is increased, and the SG supply amount command value is increased. Thus, the valve opening of the combustible gas flow regulating valve 76 is increased to increase the amount of the combustible gas supplied to the combustor 86. As a result, the pressure of the gas system (SG pressure) which is detected by the pressure gauge 66 also decreases gradually.

When the SG pressure detection value decreases, the SG pressure deviation increases, and the GID correction amount is increased and the corrected GID target value after correction is increased. As a result, the air flow rate command value, the fuel flow rate command value and the oxygen-enriched oxidizer flow rate command value are increased, and thus the air flow rate, the supply of the fuel, and the oxygen gas flow rate (oxygen-enriched oxidizer flow rate) increases gradually.

As a result, the SG calorific value, the SG pressure and the generator output are expected to recover. However, in the case of FIG. 5, the decline of the SG calorific value, the SG pressure and the generator output does not stop. On the other hand, the amount of char generation increases gradually, as the air flow, the fuel supply amount and the oxygen gas flow rate are increased.

### 3) After Time t3

In the case illustrated in FIG. 5, although the air flow rate, the coal supply and the oxygen gas flow rate have increased, the SG calorific value, the SG pressure and the generator output continue to decrease gradually after time t3.

Meanwhile, the GID target value has an upper limit that is set in advance, and at t3, the corrected GID target value has reached the upper limit. Thus, after time t3, the air flow rate, the fuel supply and the oxygen gas flow rate are saturated without further increase.

Further, the char generation amount increases gradually to time t4 and then is saturated after time t4.

### [Case of FIG. 6 (Reference Example)]

In the case illustrated in FIG. 6 as well, the SG calorific value, the SG pressure and the generator output decreases from time t1. This case is different from the case of FIG. 5 in that, due to the increase of the air flow rate, the fuel supply and the oxygen gas flow rate, after time t2, the SG calorific value becomes constant and the SG pressure and the generator output recover. This indicates that the disturbance is small in the case of FIG. 6, compared to the case of FIG. 5.

When the function of the fuel• oxygen-enriched oxidizer flow rate command value correcting unit 110 is stopped, the control targets are the generator output and the SG pressure. Therefore, once the generator output and the SG pressure reach respective target values at time t3, even if the SG calorific value is not recovered, it is deemed that the target is successfully achieved.

### [Case of FIG. 7]

### 1) From Time t0 to Time t1

The IGCC 10 is in the normal operating condition in the state where the fuel• oxygen-enriched oxidizer flow rate command value correcting unit 110 is functioning.

### 2) From Time t01 to Time t2

For some reason, the SG calorific value decreases gradually from time t1. In response to this, similarly to the case of FIG. 5, the generator output and the SG pressure decrease.

When the SG pressure detection value decreases, the SG pressure deviation increases, the GID correction amount is increased, and the corrected GID target value after correction is increased. As a result, the air flow rate command value, the fuel flow rate command value and the oxygen-enriched oxidizer flow rate command value are increased.

Further, when the fuel-oxygen-enriched oxidizer flow rate command value correcting part 110 is functioning, if the SG calorific detection value decreases, the deviation of the SG calorific value increases, and the correction amount of the fuel flow rate and the correction amount of the oxygen-enriched oxidizer increase. Therefore, the fuel flow rate command value after correction, which is determined by the fuel flow rate command value determination part 132 is greater than that of the case where the fuel• oxygen-enriched oxidizer flow rate command value correcting part 110 is not functioning. Similarly, the oxygen-enriched oxidizer flow rate command value after correction, which is is determined by the oxygen-enriched oxidizer flow rate command value determination unit 136, is greater than the case where the fuel• oxygen-enriched oxidizer flow rate command value correcting part 110 is not functioning.

Therefore, in the case of FIG. 7, the increased amount of the supply of the fuel and the oxygen-enriched oxidizer flow rate between time t1 and time t2 is large, with comparison to the cases of FIG. 5 and FIG. 6. In other words, when the fuel• oxygen-enriched oxidizer flow rate command value correcting unit 110 is functioning, the supply of the fuel and the oxygen-enriched oxidizer flow rate increase immediately.

### 3) From Time t2 to Time t3

As the increased amount of the supply of the fuel and the oxygen-enriched oxidizer flow rate between time t1 and time t2 is large, the SG calorific value, the SG pressure and the generator output rise. Further, it is possible to predict a ratio between the amount of gas produced by gasification of carbon fuel and the amount of gas produced by gasification of fixed carbon in the gasification furnace 16, from a ratio between the amount of the fuel supplied to the gasification furnace 16 and the amount of the oxygen-enriched oxidizer supplied to the gasification furnace 16. Therefore, to optimize this ratio, the correction variable determination part 128, the fuel flow correction amount setting part 130 and the oxygen-enriched oxidizer flow correction amount setting part 134 determine the correction value of the fuel flow rate and the correction value of the oxygen-enriched oxidizer flow rate. As a result, it is possible to increase the SG calorific value efficiently.

### 4) After Time t3

The SG calorific value is effectively increased, and the generator output detection value reaches the generator output target value during the increase of the SG calorific value. Then, the generator output deviation decreases, and the SG supply command value is reduced. Thus, the valve opening of the combustible gas flow rate regulating valve 76 is reduced to reduce the amount of the combustible gas supplied to the combustor 86. As a result, the pressure of the system gas (SG pressure) detected by the pressure gauge 66 increases.

Once the SG pressure detection value increases above the SG pressure target value, the SG pressure device increases in a direction different from the increase of the SG pressure deviation at time t2. Thus, the GID target value is corrected at time t4 into a decreasing direction so that the SG pressure detection value gradually approaches to the SG pressure target value after the correction.

As described above, according to the IGCC 10 of the first embodiment as well as the control method for the IGCC 10 and the control program for the IGCC 10, when the SG calorific detection value changes, the supply of the oxygen is controlled together with the supply of the fuel to the gasification furnace 16 so as to change the ratio of the supply of the oxygen gas to the supply of the air. As a result, the change in the SG calorific value is suppressed while suppressing the change in the amount of air supplied to the gasification furnace 16. Therefore, even if the SG calorific value changes, it is possible to suppress the change in the amount of the air supplied to the gasification furnace 16 from the air supply device 20. As a result, the change in the amount of the air supplied to the combustor 86 from the compressor 46 serving as a part of the air supply device 20 can be suppressed and thus, the output of the gas turbine 88 is stabilized, and the power generation amount by the generator 82 is also stabilized. Therefore, the IGCC 10 is operated stably.

Further, in the case of controlling the supply of fuel and oxygen gas to suppress the change in the SG calorific value, as compared with the case of controlling the supply of the fuel alone, the amount of char generated in the gasification furnace 16 is stabilized, and excessive generation or shortage of char is prevented. Therefore, IGCC 10 is operated stably.

Furthermore, in the case of controlling the supply of the fuel and oxygen gas, as compared with the case of controlling the supply of the fuel and the air, the fuel pressure fluctuation of the system gas in the IGCC 10 is suppressed. From this point as well, the IGCC 10 is operated stably.

Meanwhile, the SG calorific detection value has a correlation with each of the generator output target value (MWD) and the GID target value, and the generator output target value has a correlation with the GID target value via the SG calorific detection value. Therefore, if the generator output target value and the SG calorific detection value are provided, the GID target value can be set appropriately. From this perspective, in the IGCC 10, although the GID target value itself is not set based on the SG calorific detection value, the fuel flow rate command value and the oxygen-enriched oxidizer flow rate command value are corrected based on the SG calorific detection value. Therefore, even if the function or map data used for setting the GID target value in the GID target value setting part 112 does not match the current state and the GID target value is not set appropriately, the fuel flow rate command value and the oxygen-enriched oxidizer flow rate command value can be appropriately determined at the end. Thus, the IGCC 10 can be operated stably.

The control method for the IGCC 10 and the control program for the IGCC 10 can be partially used as a control program and a control method for the fuel gasification system 12.

### Second Embodiment

A second embodiment is explained in the following.

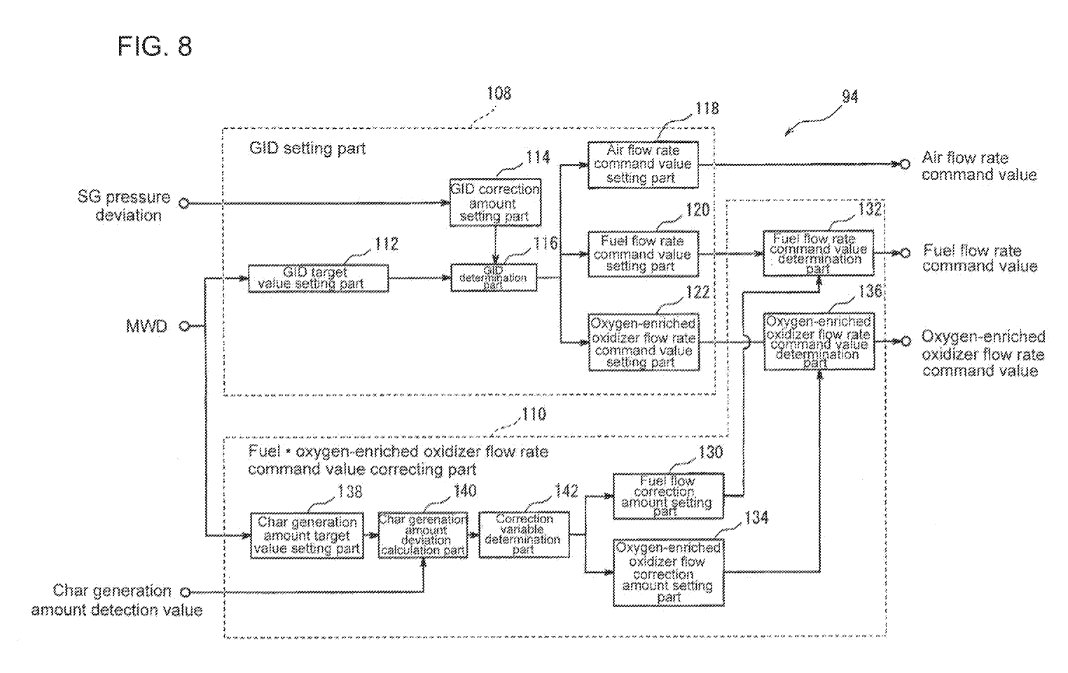

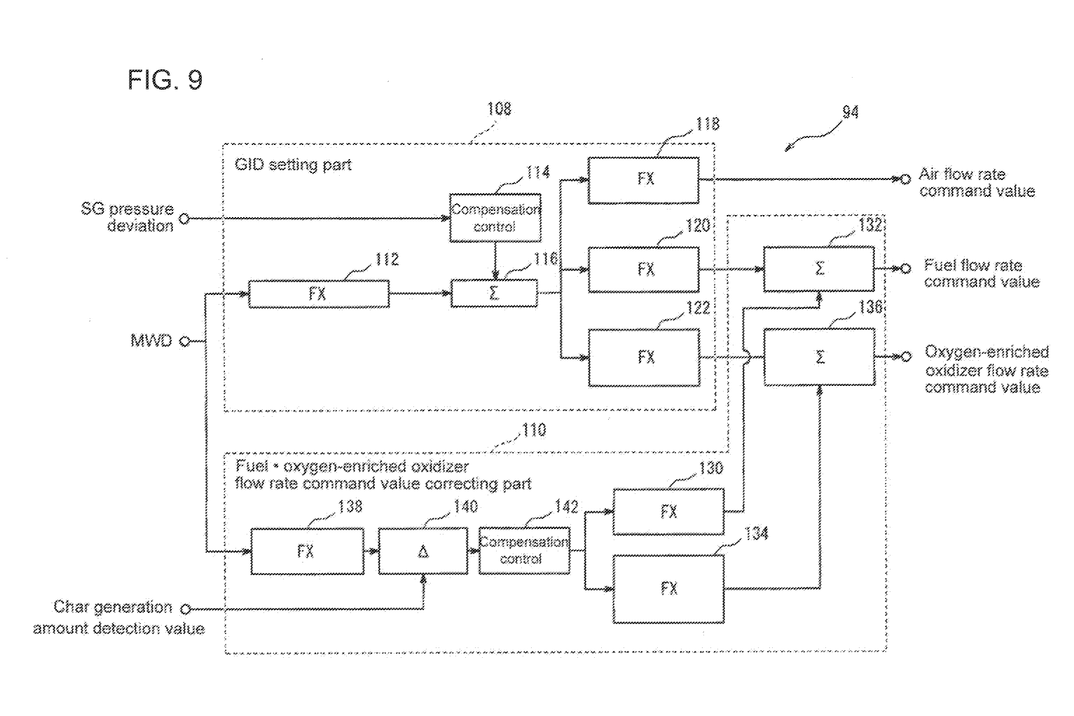

As shown in FIG. 9 and FIG. 8, the second embodiment differs from the first embodiment, in the configuration of the gasification furnace control unit 94 of the control device 26.

Specifically, instead of the SG calorific detection value, the detection value of the char generation amount is input to the gasification furnace control unit 94 from the meter 65. Further, the fuel• oxygen-enriched oxidizer flow rate command value correcting unit 110 includes, instead of the SG calorific target value setting part 124 and the SG calorific value deviation calculation part 126, a char generation amount target value setting part 138 and a char generation amount deviation calculation part 140.

The char generation amount target value setting part 138 sets the char generation amount target value based on the GID correction amount after correction, which is determined by the GID determination part, by using an appropriate function (FX) or map data.

Then, the char generation amount deviation calculation part 140 calculates the deviation between the target value and the detection value of the char generation amount (char generation amount deviation). Based on the char generation amount deviation, instead of the SG calorific value deviation, the correction variable determination part 142 performs the compensation control such as P control, PI control and PID control. Specifically, the correction variable determination part 142 determines the correction variables by using an appropriate function (FX) which is set in advance.

More specifically, the SG calorific value is used as an indicator corresponding to the calorific value of the system gas in the first embodiment, whereas the char generation amount is used as the indicator in the second embodiment.

The second embodiment also exhibits the same effects as the first embodiment. By correcting the oxygen-enriched oxidizer flow rate command value and the fuel flow rate command value based on the generation amount of the char, the char generation amount is stably controlled. As a result, the SG calorific value is appropriately kept, in the same manner as the first embodiment.

### Third Embodiment

A third embodiment is explained in the following.

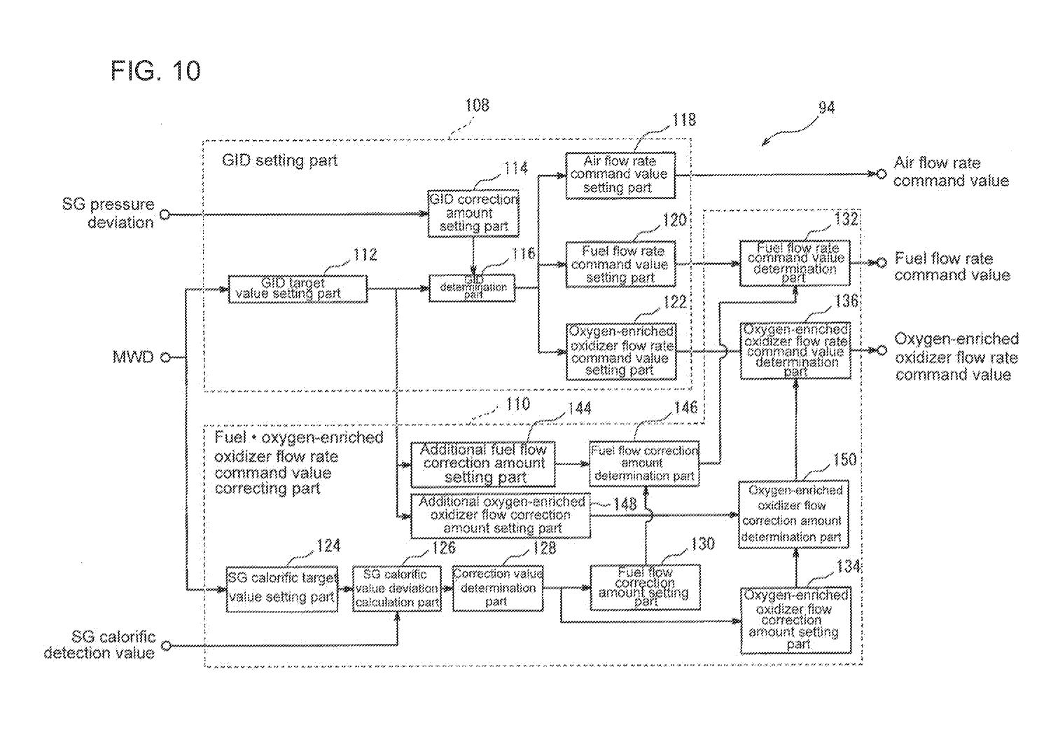

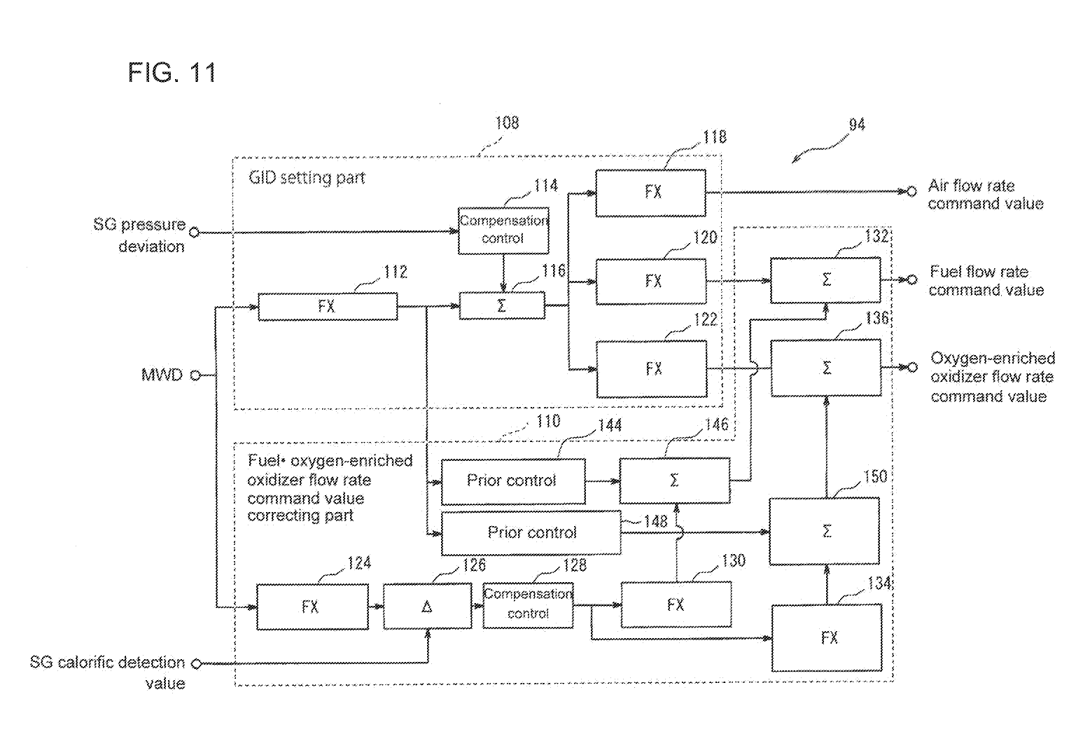

As shown in FIG. 10 and FIG. 11 the third embodiment differs from the first embodiment, in the configuration of the gasification furnace control unit 94 of the control device 26.

Specifically, the gasification furnace control unit 94 of the third embodiment additionally includes an additional fuel flow correction amount setting part 144, and a fuel flow correction amount determination part 146, an additional oxygen-enriched oxidizer flow correction amount setting part 148 and an oxygen-enriched oxidizer flow correction amount determination part 150.

The additional fuel flow correction amount setting part 144 performs a prior control. Specifically, the additional fuel flow correction amount setting part 144 sets an additional correction amount of the fuel flow rate based on the GID target value set by the GID target value setting part 112, by using an appropriate function (FX). Preferably, the function used in the additional fuel flow correction amount setting part 144 includes time differential values.

The fuel flow correction amount determination part 146 adds the correction amount set by the fuel flow correction amount setting part 130 and the additional correction amount set by the additional fuel flow correction amount setting part 144, and the obtained value is determined as a final correction value. Then, the fuel flow command value determination part 132 adds the fuel flow rate command value set by the fuel flow command value setting part 120 and the correction amount determined by the fuel flow correction amount determination part 146 so as to determine the corrected command value of the fuel flow rate after correction.

Similarly, the additional oxygen-enriched oxidizer flow correction amount setting part 144 performs a prior control. Specifically, the additional oxygen-enriched oxidizer flow correction amount setting part 148 set an additional correction value of the oxygen-enriched oxidizer flow rate based on the GID target value set by the GID target value setting part 112, by using an appropriate function (FX). Preferably, the function used in the oxygen-enriched oxidizer flow rate correction amount setting part 148 includes time differential values of the GID target value.

The oxygen-enriched. oxidizer flow correction amount determination part 150 adds the correction amount set by the oxygen-enriched oxidizer flow correction amount setting part 134 and the additional correction amount set by the additional oxygen-enriched oxidizer flow correction amount setting part 148, so as to determine the obtained value as a final correction amount. Then, the oxygen-enriched oxidizer flow command value determination part 136 adds the oxygen-enriched oxidizer flow rate command value set by the oxygen-enriched oxidizer flow command value setting part 122 and the correction amount determined by the oxygen-enriched oxidizer flow correction amount determination part 150, so as to determine the corrected command value of the oxygen-enriched oxidizer flow rate after correction.

The third embodiment also exhibits the same effects as the first embodiment.

Additionally, the gasification furnace control unit 94 of the third embodiment, by correcting the oxygen-enriched oxidizer flow rate command value and the fuel flow rate command value in consideration of the additional correction amounts, is also equipped with a feedforwad control function. And especially, when adjusting the flow rate of the oxygen-enriched oxidizer, the response of the fuel gasification system 12 is fast. Therefore, at the fluctuations of the load setting value X, the SG calorific value is converged rapidly to an appropriate value.

### Fourth Embodiment

### Third Embodiment

A fourth embodiment is explained in the following.

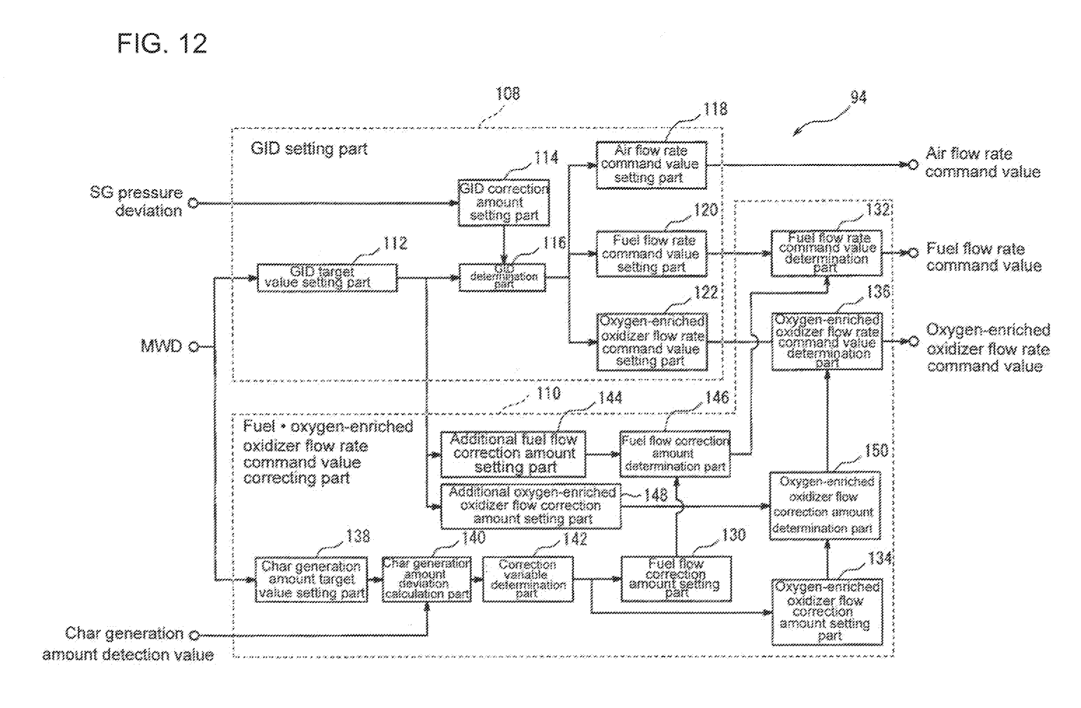

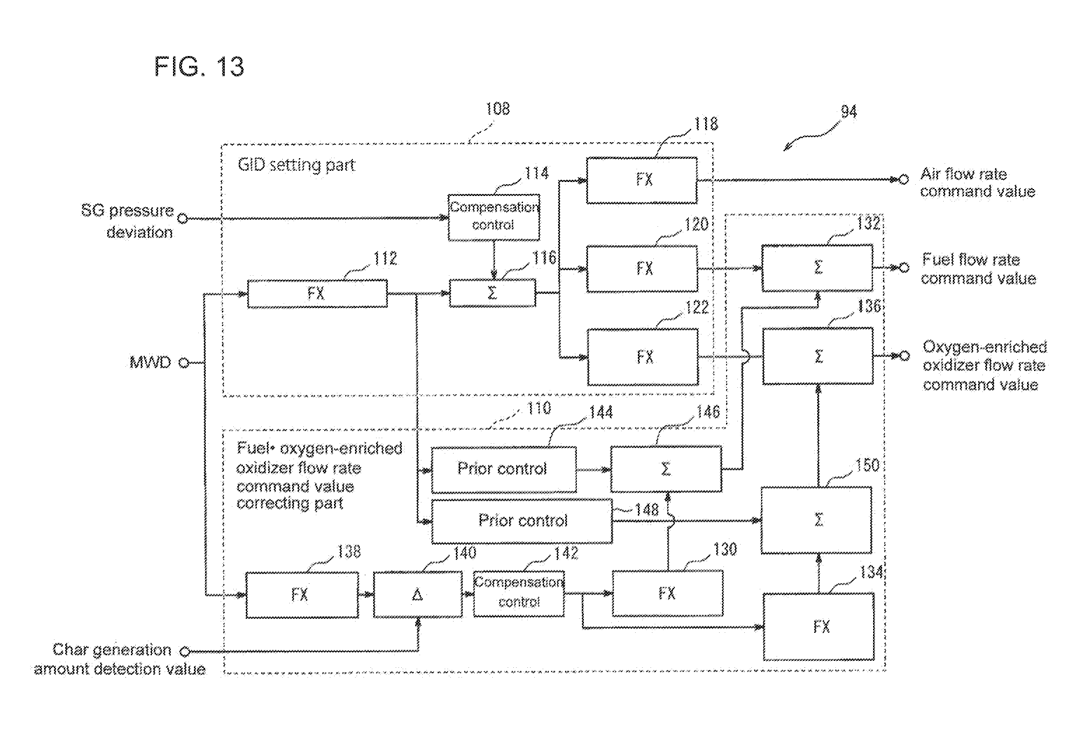

As shown in FIG. 12 and FIG. 13, the differences between the fourth embodiment and the second embodiment is the same as the differences the third embodiment and the first embodiment.

Therefore, the differences between the fourth embodiment and the second embodiment will not be described, but the fourth embodiment also exhibits the same effects as the second embodiment.

Moreover, the gasification furnace control unit 94 of the fourth embodiment, by correcting the oxygen-enriched oxidizer flow rate command value and the fuel flow rate command value in consideration of the additional correction amounts, is additionally equipped with a feedforwad control function. Therefore, at the fluctuations of the load setting value X, the char generation amount and the SG calorific value are converged rapidly to appropriate values.

The present invention shall not be limited to the first to fourth embodiments as described above, and various changes and modifications may be made without materially departing from the scope of this invention.

For instance the fuel of the fuel gasification system 12 is not limited to coal, and a carbon-hydrogen origin fuel such as coal, biomass and petroleum residuum may be used.

Further, as the indicator corresponding to the calorific value of the combustible gas, the calorific value itself is detected by the calorific value meter 68 in the first embodiment, and the char generation amount is detected in the second embodiment. However, this is not restrictive, and other indicators may be used. For example, a combination of the output of the generator 82 and the supply of the combustible gas may be used as the indicator. The combination of the output of the generator 82 and the supply of the combustible gas has a correlation with the calorific value of the combustible gas.

Furthermore, the fuel gasification system 12 may be used, besides for power generation, as a gas generating system for generating gas having a desired composition.

Moreover, the oxygen gas separated by the air separator 42 need not be 100% pure oxygen gas, and the oxygen gas may include carbon dioxide gas and nitrogen gas.

1. A fuel gasification system comprising:
a gasification furnace configured to combust and gasify fuel so as to generate combustible gas;
an air supply device configured to supply air to the gasification furnace;
a oxygen-enriched oxidizer supply device including an air separator for separating air into nitrogen gas and oxygen gas, the oxygen-enriched oxidizer supply device being configured to supply the oxygen gas separated by the air separator to the gasification furnace;
a fuel supply device configured to supply the fuel to the gasification furnace by using the nitrogen gas separated by the air separator; and
a control device configured to control the air supply device, the oxygen-enriched oxidizer supply device and the fuel supply device, the control device being configured to control, depending on an indicator that corresponds to a calorific value of the combustible gas, an amount of the fuel supplied to the gasification furnace and an amount of the oxygen gas supplied to the gasification furnace so as to change a ratio of the amount of the oxygen gas supplied to the gasification furnace to the amount of the air supplied to the gasification furnace.

2. The fuel gasification system according to claim 1,
wherein the control device is configured to control the amount of the fuel and the amount of the oxygen gas supplied to the gasification furnace depending on the calorific value of the combustible as as the indicator.

3. The fuel gasification system according to claim 1,
wherein the control device is configured to control the amount of the fuel and the amount of the oxygen gas supplied to the gasification furnace depending on an amount of char generated in the gasification furnace as the indicator.

4. A control method for a fuel gasification system which comprises: a gasification furnace configured to combust and gasify fuel so as to generate combustible gas; an air supply device configured to supply air to the gasification furnace; an air separator configured to separate air into nitrogen gas and oxygen gas; a oxygen-enriched oxidizer supply device configured to supply the oxygen gas separated by the air separator to the gasification furnace; and a fuel supply device configured to supply the fuel to the gasification furnace by using the nitrogen gas separated by the air separator, the method comprising the step of:
controlling, depending on an indicator that corresponds to a calorific value of the combustible gas, an amount of the fuel supplied to the gasification furnace and an amount of the oxygen gas supplied to the gasification furnace so as to change a ratio of the amount of the oxygen gas supplied to the gasification furnace to the amount of the air supplied to the gasification furnace.

5. A control program for a fuel gasification system which comprises: a gasification furnace configured to combust and gasify fuel so as to generate combustible gas; an air supply device configured to supply air to the gasification furnace; an air separator configured to separate air into nitrogen gas and oxygen gas; a oxygen-enriched oxidizer supply device configured to supply the oxygen gas separated by the air separator to the gasification furnace; a fuel supply device configured to supply the fuel to the gasification furnace by using the nitrogen gas separated by the air separator; and a control device configured to control the air supply device, the oxygen-enriched oxidizer supply device and the fuel supply device,
wherein the control program is operable to make the control device to realize a function of controlling, depending on an indicator that corresponds to a calorific value of the combustible gas, an amount of the fuel supplied to the gasification furnace and a function of controlling an amount of the oxygen gas supplied to the gasification furnace so as to change a ratio of the amount of the oxygen gas to the amount of the air supplied to the gasification furnace.

6. A fuel gasification combined power generation system comprising:
a gasification furnace configured to combust and gasify fuel so as to generate combustible gas;
a combustor configured to combust the combustible gas to generate combustion gas;
a gas turbine configured to be driven by combustion gas generated by the combustor;
a generator configured to generate electric power using output of the gas turbine;
an air supply device configured to supply air to the gasification furnace;
a compressor configured to supply air to the combustor, the compressor serving as a part of the air supply device;
a oxygen-enriched oxidizer supply device including an air separator for separating air into nitrogen gas and oxygen gas, the oxygen-enriched oxidizer supply device being configured to supply the oxygen gas separated by the air separator to the gasification furnace;
a fuel supply device configured to supply the fuel to the gasification furnace by using the nitrogen gas separated by the air separator; and
a control device configured to control the air supply device, the oxygen-enriched oxidizer supply device and the fuel supply device so that a power generation amount of the generator approaches a target value, the control device being configured to control, depending on an indicator that corresponds to a calorific value of the combustible gas, an amount of the fuel supplied to the gasification furnace and an amount of the oxygen gas supplied to the gasification furnace so as to change a ratio of the amount of the oxygen gas supplied to the gasification furnace to the amount of the air supplied to the gasification furnace.
